(19) United States
(12) Patent Application Publication
(10) Pub. No.: US 2011/0145028 A1
(43) Pub. Date: Jun. 16, 2011

(54) ESTABLISHMENT AND SUSTENANCE OF KNOWLEDGE CONTINUITY PROCESS

(75) Inventor: Pramila Heman KHILNANI, Mumbai (IN)

(73) Assignee: LARSEN & TOUBRO LIMITED, Mumbai, MA (US)

(21) Appl. No.: 12/965,414

(22) Filed: Dec. 10, 2010

(30) Foreign Application Priority Data
Dec. 15, 2009 (IN) 2894/MUM/2009

(51) Int. Cl. G06Q 10/00; G06Q 90/00

(52) U.S. Cl. 705/7.11; 705/500

(57) ABSTRACT

A system and method for establishment and sustenance of Knowledge Continuity Process in a phase wise manner within an organization and/or among multiple organizations comprising knowledge drivers, business drivers, a leadoff team, a knowledge expert team, a knowledge administrator, knowledge distillation and diffusion, learning's from the past archive, business leagues, expert knowledge base, knowledge delivery characterized in that said system and method comprising: identifying a predetermined stage “n” of the organization; forming the leadoff team of individuals from the organization and from knowledge vendor; linking the knowledge drivers with the business drivers by said leadoff team; measuring a stage ‘n+1’ of the organization by individuals of the knowledge vendor; and providing a continuous improvement.

### CROSS REFERENCE TO RELATED APPLICATIONS

This application claims benefit of Indian Patent Application No. 2894/MUM/2009 filed Dec. 15, 2009, which is hereby incorporated by reference in its entirety.

### FIELD OF THE INVENTION

The present invention relates to the field of Knowledge Management for sharing knowledge and expertise within an organization and/or among multiple organizations. In particular, the present invention is a method and a system for forming and introducing knowledge continuity process within an organization and/or among multiple organizations.

### BACKGROUND

Most organizations have recognized the need for Knowledge Management within the organization. However, the term knowledge management has been applied to very broad spectrum of activities and knowledge management applications provide much diversified functionalities, as described by Knox Haggie and John Kingston in their paper “Choosing Your Knowledge Management Strategy”, published in the Journal of Knowledge Management Practice, Volume 4, and 2003 page 1, 4-8.

The senior employees who have been within the organization, for a considerable amount of time, gain significant experience in their subject matter. Through the experience the employee becomes particularly knowledgeable about the subject associated with their profile. Still, the expertise gained by these experienced employees might not be completely utilized by the organization since its existence or where it resides may not be accessible to others seeking that knowledge. Moreover, if the knowledgeable employee leaves the organization without divulging his knowledge and experience, it results in huge loss to the organizational memory and investments in terms of redevelopment. To redevelop this knowledge, organizations have to invest in terms of time, money, and people, and still may not be able to achieve the same level of competence and proficiency.

Knowledge capture and elicitation are specifically essential for implementing knowledge continuity process. Moreover, it is about communicating knowledge which should be exercised not on specific need-based criteria but at organizational levels. This phenomenon has been described by Kimiz Dalkirin in the book, Knowledge Management in Theory and Practice: Theory Into Practice, 2005, chapter 4, pages 102-105.

Hamilton Beazley describes the importance and advantages of ‘Knowledge Continuity’ in his article, “Knowledge Continuity: The new competitive advantage”, April 2003, published online by ASAE and The Center. The steps for successful knowledge-continuity initiative are also discussed.

Authors Boenisch, Beazley and Harden in the abstract of their paper “Knowledge continuity: The new management function”, published in the Journal of Organizational Excellence, Volume 22 Issue 3, May 2003, Pages 65-81, describe the importance of Knowledge dissemination and recognizing value of knowledge in an organization's functioning. They also mention the drawbacks of re-creating the knowledge every time by a person's successor.

US patent application 20030130880 A1 discloses that an information technology service provider assists an organization in establishing and using a knowledge network. The organization benefits by sharing expertise between individuals in the network. The process for initially establishing or launching a knowledge network includes forming an initial work group to perform an assessment and develop an enablement process. The work group selects an executive sponsor, therewith reviewing the assessment and plan. A core team of experts in a domain of knowledge is identified and educated. The core team develops operational plans and guidelines. A database and network tool is provided. A launch meeting is held and plans approved. The core team uses the network tool to share intellectual capital and the organization benefits. Additional members may be recruited. Health check interviews are periodically conducted.

However, the present invention is different from this document. The present invention deals with the continuous revision of the captured knowledge assets, leadoff team is capable of identifying the linkages between the knowledge drivers and business drivers and the leadoff team includes individuals from the organization and also from the knowledge vendor team. In the present invention the knowledge expert team is nominated through management support ensures compliance to the standards set by the organization for definition of an ‘expert’. An Expert is identified with the help of software search engine tool—means to sort information on the basis of various criteria like skill set, experience, years of service, subject matter knowledge, publications such as white paper, articles, books, job responsibility. In the present invention, the ‘expert knowledge base’ has ability to solve problems and continuously learn. It contains both factual and heuristic knowledge. The phase wise classification acts as measurement/reference points at each stage of knowledge continuity process roll out. This in turn ensures efficient and complete implementation through regular status checks and feedbacks of each stage (measuring stage ‘n’ and stage ‘n+1’ as shown in the diagram and draft). The present invention advocates both establishment and sustenance of knowledge continuity and thus, without phase wise classification, the road-map would not be concrete.

Many times it is observed that one time exercise is carried out to capture the knowledge with the help of Knowledge Drivers but the difficult part is continuous revision of these captured knowledge capsules/assets and also adding more capsules to the current knowledgebase. It is therefore becoming imperative for organizations to preserve its knowledge in order to leverage its business' capabilities. The present invention addresses the knowledge category by consigning specific subject areas based on constructing, establishing and sharing experiences. The implementation of the knowledge continuity process from the initiation phase to the roll-out phase needs to be executed clearly in order to avoid deadlock at various levels. Moreover the organizations will not be able to sustain the expected benefits in the absence of such a scenario. It is believed that the present invention would constitute a significant advancement in the art.

### OBJECT OF THE INVENTION

An object of the present invention is to provide a method for establishment and sustenance of knowledge continuity process within an organization and/or among multiple organizations.

Another object of the present invention is to provide a system for establishment and sustenance of knowledge continuity process within an organization and/or among multiple organizations.

Another object of the present invention is to provide assistance to all members in the organization to respond faster to market, develop operational excellence and deep customer relationship.

Another object of the present invention is to provide guidance for new and existing members.

Another object of the present invention is to provide a platform where large teams would participate in gathering, organizing and disseminating the knowledge.

### SUMMARY

In accordance with one embodiment of the invention there is provided a method for establishment and sustenance of Knowledge Continuity Process in a phase wise manner within an organization and/or among multiple organizations comprising knowledge drivers, business drivers, a leadoff team, a knowledge expert team, a knowledge administrator, knowledge distillation and diffusion, learning's from the past archive, business leagues, expert knowledge base, knowledge delivery characterized in that said method comprising:

identifying a predetermined stage “n” of the organization;

forming the leadoff team of individuals from the organization and from knowledge vendor;

linking the said knowledge drivers with the said business drivers by said leadoff team by selecting knowledge drivers appropriate to business drivers based on organizational needs;

measuring stage ‘n+1’ of the organization by individuals of the knowledge vendor; and providing a continuous improvement.

Identification of the knowledge drivers, business drivers, a leadoff team, a knowledge expert team and a knowledge administrator is done using Software Search Engine tool means which assist in resume search and skill identification. A search through a Search Engine tool/means is the organized pursuit of information. The information can be located in a collection of documents, web pages, and any other sources within the organization. The tool/s has the extensive library of search strings. And based on the desired profiles and criteria like number of years of service, years of experience, subject matter knowledge, skill set, publications—white papers, articles, books etc, job responsibility the results are sought. The software tool/s has the capability to store the search strings so that the search can be carried out at various intervals.

According to another aspect of the present invention there is provided a system for establishment and sustenance of Knowledge Continuity Process in a phase wise manner within an organization and/or among multiple organizations comprising knowledge drivers, business drivers, a leadoff team, a knowledge expert team, a knowledge administrator, knowledge distillation and diffusion, learning's from the past archive, business leagues, expert knowledge base, knowledge delivery characterized in that said method comprising:

means for identifying a predetermined stage “n” of the organization;

means for forming the leadoff team of individuals from the organization and from knowledge vendor;

means for linking the said knowledge drivers with the said business drivers by said leadoff team;

means for measuring stage ‘n+1’ of the organization by individuals of the knowledge vendor; and means for providing a continuous improvement.

### BRIEF DESCRIPTION OF THE ACCOMPANYING DRAWINGS

The accompanying drawings, which are incorporated in and constitute a part of this specification, illustrate exemplary embodiments of the invention and together with the description, serve to explain the principles of the invention. In the drawings:

FIG. 1 is the stage diagram for the knowledge continuity process in accordance with the present invention.

FIG. 2 is a flowchart illustrating steps in accordance with the present invention.

FIG. 3 illustrates the Business Driver and corresponding Knowledge Driver.

FIG. 4 illustrates the different roles for knowledge continuity process.

FIG. 5 illustrates a flow chart of the commence phase in the method of the present invention.

FIG. 6 illustrates a flow chart of the discover phase in the method of the present invention.

FIG. 7 illustrates a flow chart of the manage phase in the method of the present invention.

FIG. 8 illustrates a flow chart of the discern phase in the method of the present invention.

FIG. 9 illustrates a flow chart of the continuance phase in the method of the present invention.

### DETAILED DESCRIPTION

For a better understanding of the present invention, together with the other and further objects, advantages and capabilities thereof, reference is made to the following disclosure and the appended claims in connection with the above described drawings.

A knowledge continuity process herein shall mean a methodology to recognize organization's knowledge capital, effective usage of knowledge capital and application of knowledge capital for adaptation to changes in work environment.

The present invention has a unique combination of five different strategic phases for forming and introducing Knowledge continuity process within an organization and/or among multiple organizations.

The phase wise classification acts as measurement/reference points at each stage of knowledge continuity process roll out. This in turn ensures efficient and complete implementation through regular status checks and feedbacks of each stage (measuring stage ‘n’ and stage ‘n+1’ as shown in the diagram and description). The present invention advocates both establishment and sustenance of knowledge continuity and thus, without phase wise classification, the road-map would not be concrete.

Also with phase wise classification the deliverables can be clearly defined at the outset of the project by the teams. If the deliverables are not achieved or there are deviations, then escalation can take place at the right time and road blocks can be addressed rather than waiting till the end of the project.

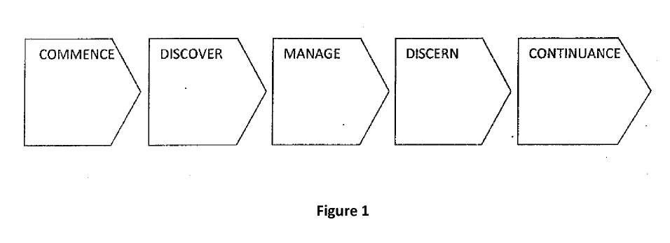

FIG. 1 shows the five stages for institutionalization of the knowledge continuity process are: Commence Discover, Manage, Discern, and Continuance.

Commence Phase:

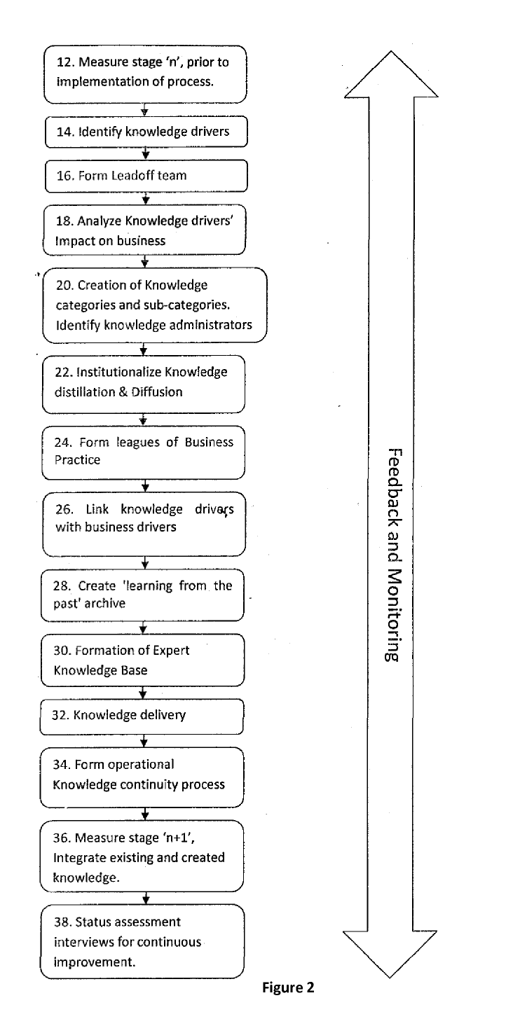

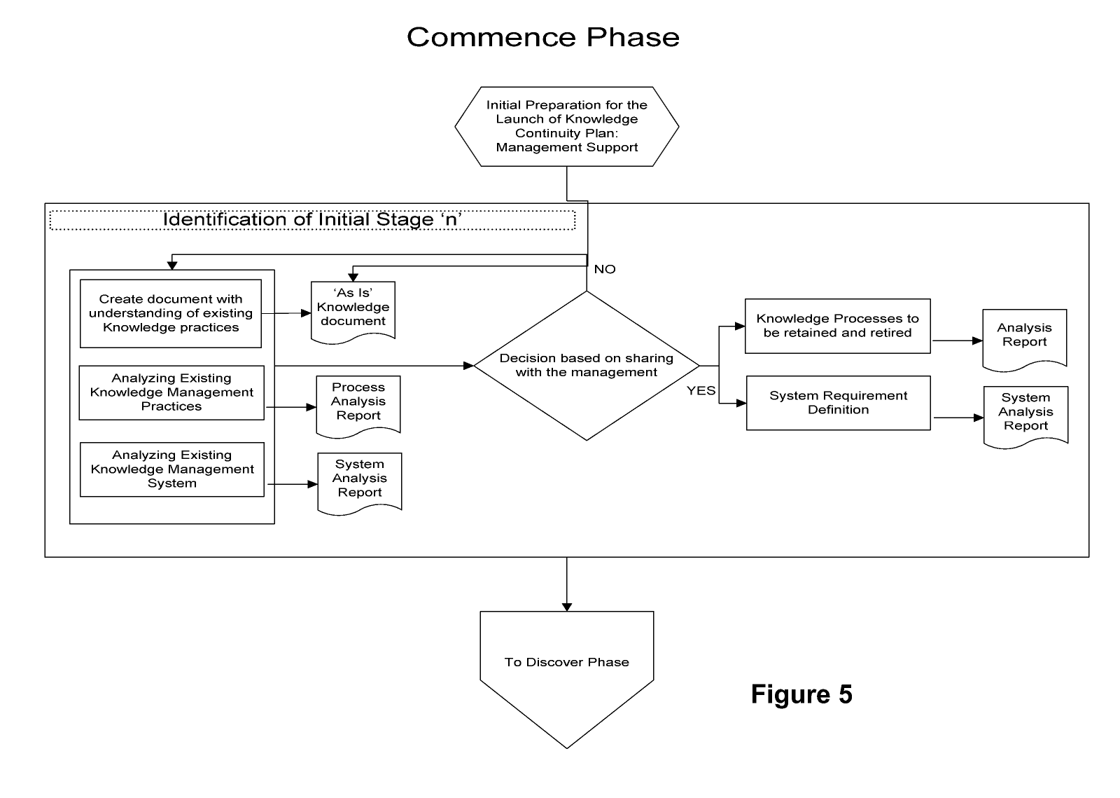

FIGS. 2 and 5 illustrates a flowchart illustrating steps in accordance with the present invention. The object of the present invention is to provide knowledge continuity process within an organization and/or among multiple organizations. For this purpose, it is essential to identify a stage ‘n’ of the client organization in Step 12, which is defined as the ‘Commence’phase when the knowledge continuity process is not in existence. Post-implementation would be a significant measure of the effectiveness to gauge the benefits received by the client organization. This measure is carried out by the members from knowledge vendor and recorded for future assessment of stage ‘n+1’. The measurable features which shall be weighed but are not restricted to, are introduced succinctly in the ‘Discern’ stage.

The members from knowledge vendor also gain support in terms of leadership from management for a top-down implementation of the knowledge continuity model, and active participation commitment. Prior to the ‘Discover’ stage which follows, it is essential to carry out this step effectively.

Discover Phase:

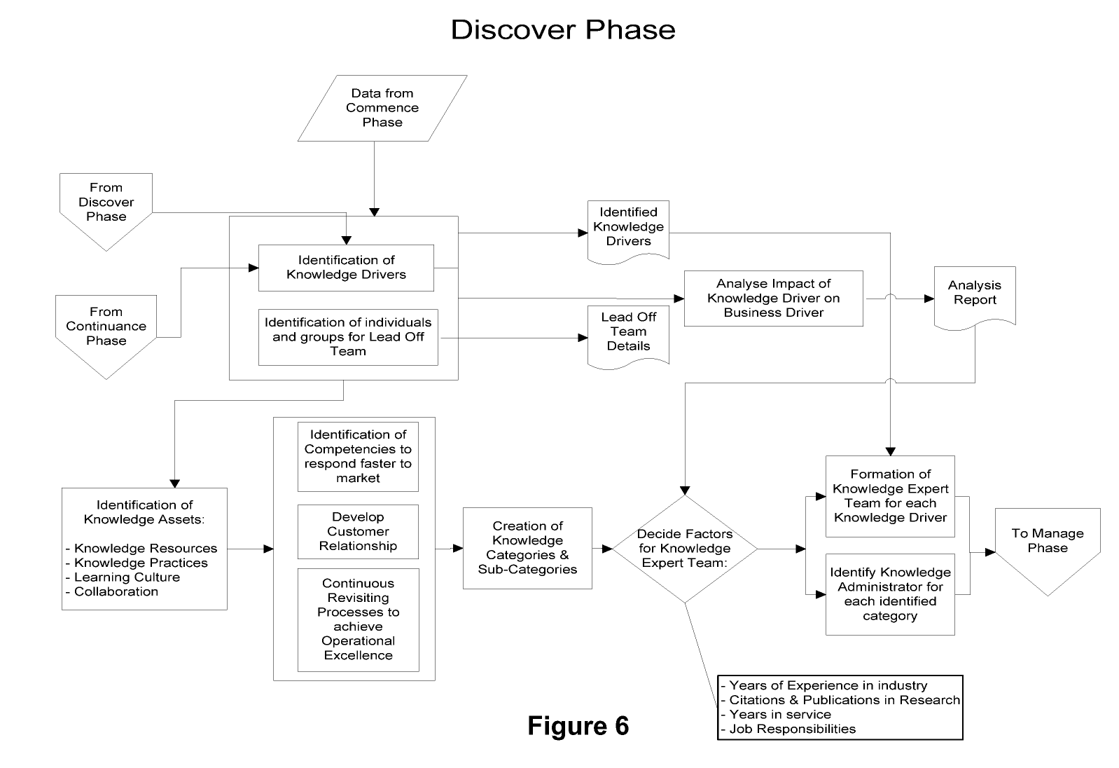

FIG. 2 and FIG. 6 illustrate a flow chart of the discover phase in the method of the present invention. An initial identification of knowledge drivers is carried out in Step 14. Knowledge drivers are those identities (areas or systems) from where one needs to capture the knowledge. This could include the individuals, groups or areas of the organization desiring advancement from the knowledge continuity process. The illustration is extended to components with designated characteristics for multitude levels of capability. In particular, the components may include organizational roles and responsibilities, network tools, knowledge strategy, tacit knowledge and expertise, and knowledge elicitation.

Forming the leadoff team in Step 16 includes those members of the organization who are capable of analyzing the knowledge drivers' impact on business in Step 18 and also identifying the linkages between the ‘knowledge drivers’ and ‘business drivers’. Thus the team comprises of members at various levels and also those who have deep business knowledge and expertise in their respective field. This team will have members from the knowledge vendor team too.

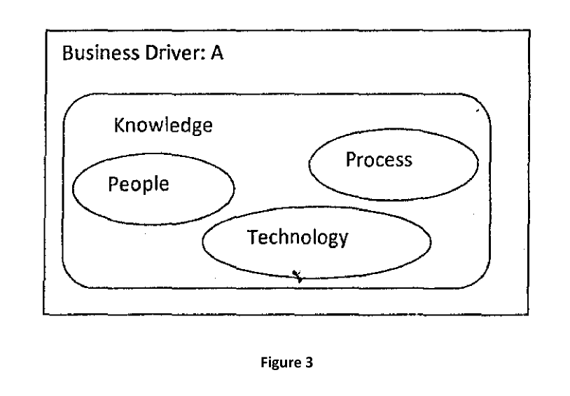

The identified business drivers in an organization are achieved through means of a set of well-defined activities. The efficiency and execution of these actions are associated with experience-level and knowledge which the organization has. It is essential to preserve both this, knowledge and the experience, to maintain the knowledge continuity spectrum in an organization. For all the identified business drivers, it is essential to preserve and build-on the acquired knowledge level. It is also important to know the key knowledge and intellect of resources (mainly classified as—people, process and technology) working towards achievement of a business driver's goal. These identified knowledge drivers are then grouped under the related Business driver to establish the linkage between the two as shown in FIG. 3.

The Knowledge Strategy varies with the organizational needs with various scenarios being interdependent (Business driver—Knowledge driver linkage)

When the organization is seeking Market Growth, the Knowledge driver gets linked with Business driver with factors as under:

| Business Driver | Knowledge Driver |
|---|---|
| New Product to be introduced | Product Enhancement and Innovations |
| in the Market | |
| Exploring New Markets | New Competency Building and exploiting |
| | imperfections in the market |
| Pricing and Distribution | New Business Models |
| Strategy | |
| Product & Patent Leverages | Product & Process related Patent |
| | Knowledge |

When the organization is seeking Operational Excellence, the Knowledge Driver gets aligned with Business Driver as under:

| Business Driver | Knowledge Driver |
|---|---|
| Business Process | Process Innovation & Reform |
| Re-engineering | |
| Supply Chain Management | Knowledge Sharing and dynamic |
| & Logistics | response to market needs |
| Governance & Quality | Development Learning Culture |
| Consciousness | |

When the organization is seeking alignment with the Clients, the Knowledge Driver gets aligned with Business Driver as under:

| Business Driver | Knowledge Driver |
|---|---|
| Clients Relationship Building | New ways of doing business-innovation |
| (retention of clients) | ideas |
| Understanding Client | Customer Knowledge Integration |
| Business Needs | Focus on what we know and what we |
| | need to know |
| Alliance and Partnering | Organization Branding |

The key role of the team is as under:

1. Identification of the Competencies to respond Faster to Market: Identifying those competencies which will help the organization to respond faster to the market or increase the reach of the organization in the market place. In other words Knowledge Capsules/assets will assist in reduction of the Time to Market. The sales and business development team will benefit immensely, as most of them work in different locations with minimal support. The knowledge created will help in increasing the confidence to sell the organizational offering effectively.

2. Develop Customer Relationship: Help the organization to develop deep relationship with the customers. With the help of knowledge base the front line employees (at all levels) will be able respond better to the business needs of the customers. The products/solutions will be able to map with the customer current business and thus deep relationship will get developed. Every customer will get unique treatment and eventually will also be the extended family of the Knowledge Continuity process.

3. Operational Excellence: Knowledge Base which continuously undergoes revision from time to time helps the organization in evolving process innovations in various areas which in turn leads to operational excellence. The processes which are redundant with changing times can be amended to suit the current business needs. Thus continuous improvement within the organization becomes way of life.

The leadoff team has responsibility to support the creation of knowledge categories and sub-categories in Step 20 which would be beneficial and is expected to assist the knowledge continuity process in further stages.

Further, the leadoff team forms the knowledge expert team for each knowledge driver. The knowledge expert team consists of members from the organizations and is nominated through the management and/or executive support. Various factors which should be weighed, but not restricted, to the nominations would be the years of experience in industry, background citations and publications (whitepapers, articles, books, etc.) by the members, years in service, job responsibilities held etc.

A knowledge administrator in Step 20 is nominated for each of the identified categories in the knowledge continuity process. Knowledge administrator is an individual who is the custodian of the knowledge continuity process in the designated category and will shoulder the responsibility of a successful launch and establishment of the knowledge continuity process along with the leadoff team. Various factors which should be weighed, but not restricted, to the nominations would be the years of experience, job responsibilities held, years in service, citations and publications. An individual who was already part of the leadoff team may also, at the same time, shoulder the responsibility of the knowledge administrator.

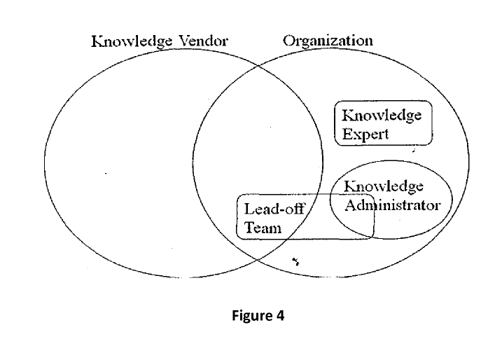

FIG. 4 illustrates the different roles of knowledge vendor, organization, lead off team, knowledge expert and knowledge administrator in the present invention.

Subjected to the business agreement, the organization's member(s) in the leadoff team may be expected to:
1. gain Management's support for knowledge continuity process enrollment and work-force time commitments.
2. incorporate the knowledge continuity process into individual performance of the workforce so that it is embedded in the organization's culture over a period of time. Active participation and supervision of the vendor would be essential along with periodic assessments.
3. associate with and cooperate as and when requested for the activities pertaining to the continuity process.
4. propagate the importance of knowledge sharing and continuity process, and link it to business drivers.
5. provide assistance in resolving any unforeseen issue which may arise during any of the phase.

Manage Phase:

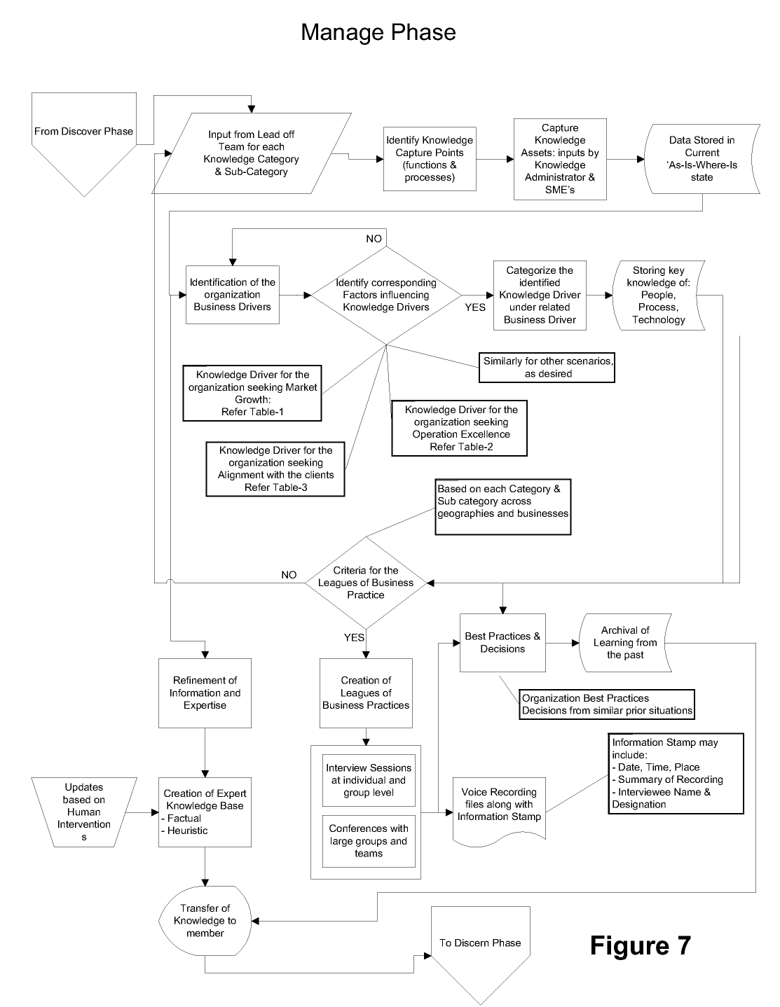

FIGS. 2 and 7 illustrate a flow chart of the manage phase in the method of the present invention. Manage phase that depicts ‘formation of a knowledge gathering process’ which involves evolution, of both high level and detailed process on knowledge gathering across the organization commences. The functions and/or the processes which are identified as knowledge capture points are finalized by the leadoff team. The Knowledge continuity process is prepared to capture the knowledge assets in consultation with the knowledge administrators and subject matter experts, and their availability. The knowledge is captured on the basis of ‘As-Is Where-Is’ principle which implies that the knowledge is captured in current state/form in which it is available from source.

In Step 22, knowledge distillation and diffusion is initiated, which forms an integral part of the Knowledge continuity process. The Knowledge continuity process embodies provision to capture the knowledge assets both at individual and group level. For this purpose interview sessions are conducted and as each question is posed, a copy of the answer is recorded through any of the equipments which supports voice recording functionality, such as, but not limited to, microphones, voice recorders and other devices. The method may include any number of questions and the answers may include information from one or more sources. In cases where group of individuals are involved, the session in step 22 may be modified to be a conference of all participants.

An information stamp is marked at the start or at the end, or during the session as desired. An information stamp may include, but not restrict to, the specifics such as time, place, and date, summary of the recording, individual's details (such as names, designation) and others.

Based on the knowledge asset, the knowledge distillation and diffusion may be carried out as one individual after another, on a one-to-one basis. Also an individual can comment and add to, if the other has missed out something, which shall resemble a many-to-one scenario in a conference. Another mode would be to administer the summary by every participant at the conclusion of the conference. At the same time the session would serve as a platform for the individual or the conference, to contribute on various dimensions of the usage of this knowledge base in future.

Knowledge distillation process comprises of creation of Leagues of Business Practice, Expert Knowledge Base, and Capturing Learning from the past.

Step 24 shows the formation of Leagues of business practice. The leagues play a vital role in the knowledge continuity process and is formed for each category and sub-category identified across various geographies and businesses. In some cases these communities can be located at one location or can be part of one department. They serve a dual purpose:
1. Allows the team to come together and meet at one platform.
2. Serves a common ground for the team to come together and share.

As the Knowledge continuity process strives towards sustenance of knowledge on continuous basis such as introducing the voice recording tools along with the information stamp. The members record their meeting and upload these voice files through the technical means. This has dual advantage i.e. it saves time of creating elaborate Minutes of the Meeting and secondly, it allows the members to capture the logic behind the decision on which they arrived. The voice recordings along with the information stamp is uploaded and stored in Document Management System or Digital Library. A document management system (DMS) is a computer system used to store and track electronic documents and/or images of paper documents. The Document Management System is also used to store Knowledge Assets and supporting documents.

The logic and the circumstances behind the decision(s) in a meeting are always missed out while framing conclusions or summary in the form of Minutes of Meeting. The knowledge continuity process thus traces, captures and archives the above parameters for reference in future, whenever the need arises.

In step 28, By way of example, an archive is created which contains ‘learning's from the past’ from the captured details. The captured details assist in linking these knowledge drivers to the people, information, and process which posses this knowledge, to support the fulfillment of business objective, and provide strong fundamental assistance in the dynamic environment with changing times. The knowledge based activities are archived for future reference. These can be tracked and applied for training employees in an environment which closely resembles the heat of a real-life scenario. The recorded discussion would also assist to a large extent in learning from past experience and influence to incorporate best-practices and decisions from similar prior situations.

Further in the knowledge continuity process, an Expert-Knowledge base is created in Step 30. The expert-knowledge base is a repository with the objective to deliver—“right knowledge at the right time to the right people”. All the expertise and refined information which have been collected through the years of professional experience and practice is brought together and accumulated under this unique point of reference. The expert-knowledge base comprises of the established and proven facts for ready-reference and is materialized using the technical means described in step 32. Expert Knowledge Base is software which has the ability to solve problems and continuously learn. The user can raise query and like any human expert, this system can address the query and give appropriate answer from the database. The Expert Knowledge Base contains both Factual and Heuristic knowledge. The Expert Knowledge Base helps in knowledge transfer to anyone who is not familiar with the Knowledge Continuity Process. It ensures that the knowledge which is captured is of expert nature but its expression is in simple and easy to understand for any common man or a new employee in an organization. Intelligent queries raised by the employees can be answered by the system and the same can be demonstrated to various teams.

Discern Phase:

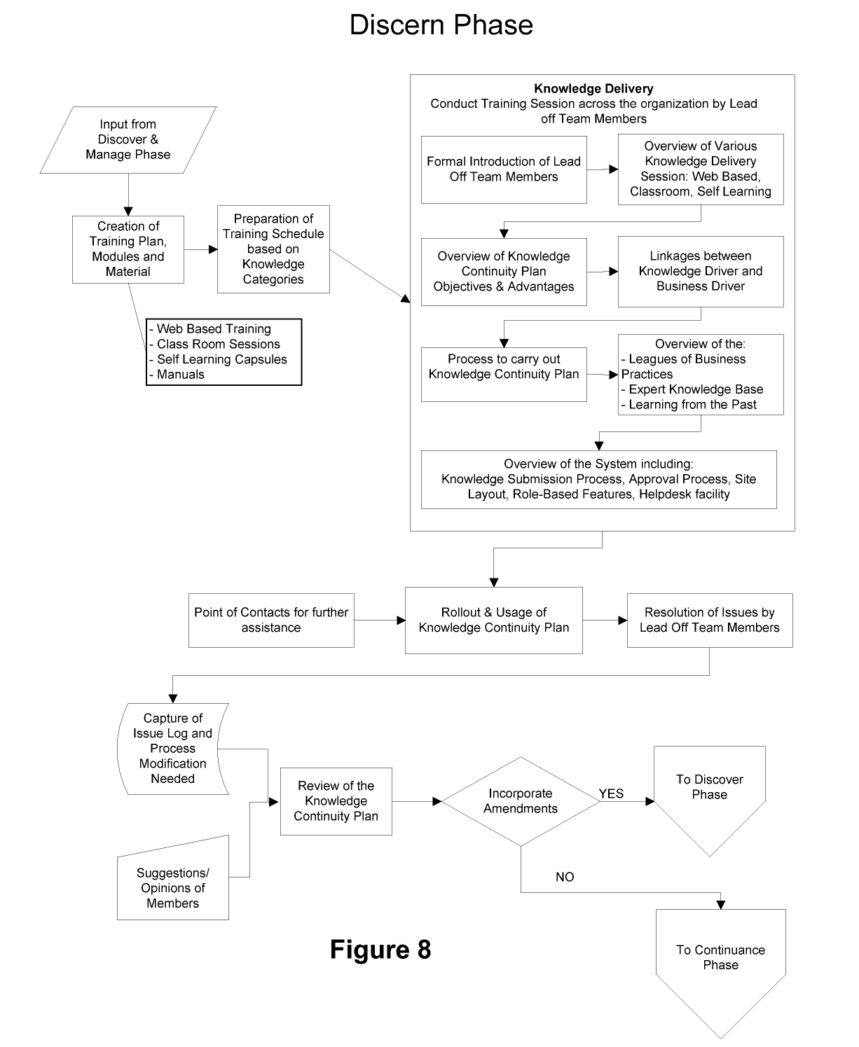

FIGS. 2 and 8 illustrate a flow chart of the discern phase in the method of the present invention. In step 32 Knowledge delivery is instituted which includes the technical means, training for the individuals of the organization, technological support if needed and other dependencies. Knowledge continuity education may also be provided as an essential part of this scheme, which marks the initiation of ‘Discern’ phase.

The leadoff team shares the information about the linkages between the knowledge drivers and the business drivers, in addition to the reviewed operational process which logically follows step 32. Any other specifics to a particular category are also finalized and conveyed.

Technical means includes integrated technologies such as workstations, Database servers, network layout and software such as various content management portals known in the art of knowledge management. The Content Management System (CMS) is used to ensure management of the work in a collaborative manner. These computer-based procedures are designed to do the following:

Facilitate large number of people to contribute and share stored data;

Control access to data, based on user roles (defining which information users or user groups can view, edit, publish, etc.);

Assist in easy storage and retrieval of data;

Eliminate redundancy and duplicity of data;

Improve the ease of report writing;

Improve communication.

Another big advantage of Content Management System is version control, which allows to store the same knowledge asset in different versions. Any modification and/or enhancement to the existing knowledge asset can be stored in a separate additional document. Thus all versions from old to new are available for reference. Any other relevant means under desired setup may also be provided for use.

Knowledge continuity education is carried out in order to integrate existing and created knowledge, by dividing the individuals into suitable-size groups. An educational session consists of members from leadoff team and knowledge vendor, who instruct and address each group. Parallel sessions may be conducted depending upon the availability of constituent resources. The participants are educated about the knowledge continuity process, and the process to carry out the Knowledge continuity process.

Training may be carried out through manuals, online tutorials, class-room mode, any other method or a combination of more than one method. The suitable size of the group and the training methodology may be decided based on the information gathered in the detailed assessment performed in step 18.

The educational session comprises of the introduction to the knowledge continuity process, its objectives and its advantages, along with the formal introduction of lead-off team and the knowledge administrators with individuals of the organization. On-line tutorials and other resources are reviewed and distributed. At the same time, the point of contacts for further assistance and resolving unanticipated issues during roll-out are shared. The session also focuses on the optimum usage of the technical means through live demonstration. The demonstration may include vital procedures such as knowledge submission process, approval process, site-layout, role-based features, helpdesk and the vital methodology essential to co-function in order to reach out to the mission of knowledge continuity process.

A preliminary version of operational knowledge continuity process and protocol is formed in Step 34. This operational process is reviewed as per the characteristics of every category and sub category identified above and further customized advancements are made without diverging from the scope of the process. The operational knowledge continuity process constitutes the stage ‘n+1’ with reference to stage ‘n’ in ‘Commence’ phase, where a formal, documented knowledge continuity process has been institutionalized in the organization in Step 36. The immediate influence on the business would constitute a range of benefits including concrete forecast on future business needs and preserving competitive advantages while creating new ones, amongst others.

Continuance Phase:

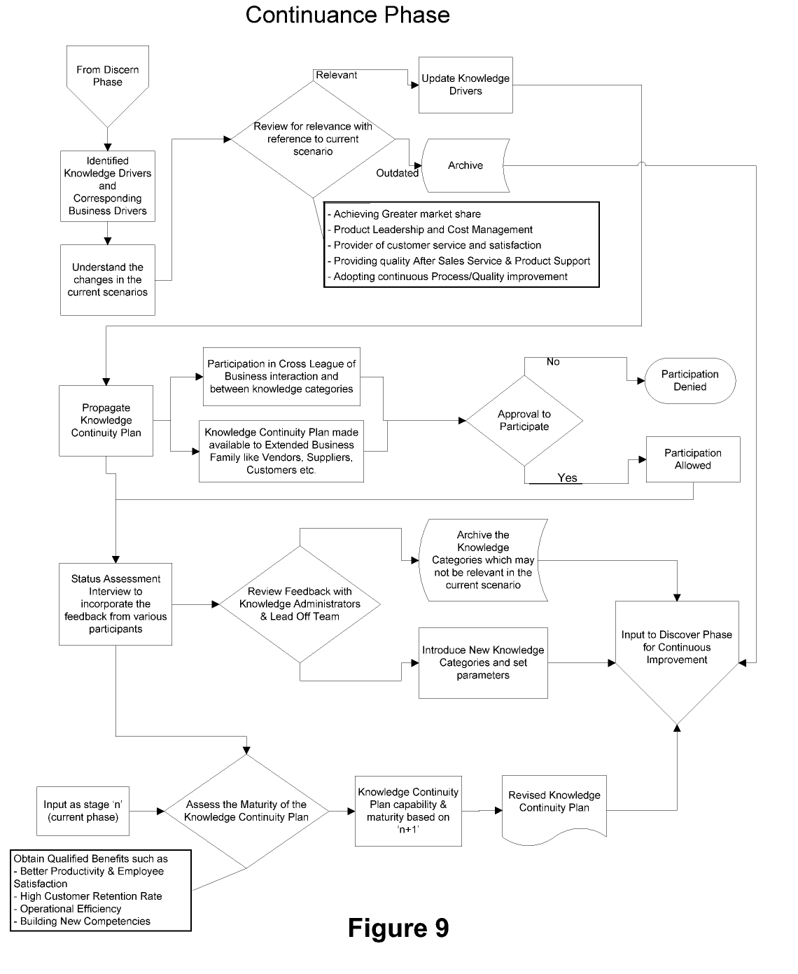

FIGS. 2 and 9 illustrate a flow chart of the continuance phase in the method of the present invention. The final stage of ‘Continuance’ phase where, the Intellectual capital is managed in accordance with the Knowledge continuity process and the organization receives its benefits.

Managing intellectual capital involves continuously cross checking the relevance of current knowledge drivers to the business drivers. Those knowledge assets which are no longer relevant in the current market scenarios are put in archive knowledge folders, which in turns contribute to the creation of Historical Knowledge Base. Thus managing and creating new intellectual capital involves one or more of these activities:

Assisting in achieving Greater market share

Assisting in maintaining the leadership position in major product groups

Striving for world class provider of customer service and satisfaction

Product cost management

Maintaining high quality standards

Optimum utilization of resources, cost control and better productivity

Providing quality After Sales Service

Adopting continuous Process/Quality improvement

Continuous improvement in manufacturing throughput

Providing quality products

Achieve cost reduction

Efficient operations

Better online information systems

Better integration among various business processes in line with global trends

To maximize the advantages, other individuals from the organization are encouraged to participate by communicating presence of the knowledge continuity process, its present status and operating protocols, throughout the length of the organization. Such other members may not belong to the addressed subject category, but should possess a genuine interest in functioning and learning more about that particular category.

The process provides for approvals in case some members seek to learn or have the access to additional knowledge not pertaining to their area of work. The whole purpose is also to secure the Organization Memory and avoid misuse of these well formed knowledge capsules/assets and leakages to the competitors.

Status assessment interviews in Step 38 may be conducted periodically and reported to lead-off team members and knowledge administrators to administer feedback. More lead-off members can be inducted as the business grows and new categories can be created as per requirements. These managing parameters would ensure adherence to established procedures and lead to continuous improvement.

With the rate of knowledge continuity capability and maturity witnessed in the organization an optional, formal, documented Process to adhere to the knowledge continuity process may be introduced and followed. The Knowledge Continuity process at a mature stage can be made available to the extended business family too. This will help in creating a 360 degree view of knowledge and its applicability.

In order to obtain quantifiable benefits from the knowledge continuity process being an integral part of business, certain effective factors would be measuring intelligence transfer to employees and building Competency. This would in turn lead to better productivity and employee satisfaction. The fact-based decision making supports high customer retention rate, superior customer-defined quality and better customer understanding. All these variables would be directly linked with availability of relevant knowledge which increases efficiency, employee capability, and opportunity recognition from Efficiency in operations.

While there have been shown and described what are at present considered to be the preferred embodiments of the invention, it will be perceivable to those skilled in the art that various changes, substitutions, variations, alterations and modifications may be suggested that can be made herein and it is intended that the present invention encompass such changes without departing from the scope of the invention as defined by the appended claims.

Explanation of a Few Terms:

Knowledge Vendor:

Knowledge Vendor is the service provider in, but not limited to, knowledge management or similar fields, which undertakes the implementation of knowledge continuity process. It can be an individual consultant, an organization, or any such entity providing knowledge consulting services or undertaking/implementing Knowledge continuity process.

Knowledge Assets:

Knowledge Assets are defined as knowledge resources—which can be described as ‘what do we know and where does it resides’; knowledge practices—what processes are in place and what processes specifically leverage knowledge resources; Culture and learning—How does the organization participate and deal with the know-how; and Collaborate—How does the organization support this know-how.

Business Drivers:

Business Drivers are the set of key factors which mainly ‘drives’ the business ahead and are decided upon based on the particular market and industry. The term or the concept ‘business driver’ is not novel to this invention, and is rather a proven concept in an organization's growth strategy. The identification and prioritization of such key factors is essential and critical first step for a business. However, the research and knowledge put in the various parameters to decide upon its drivers is often not archived and revised. Consequently, the factors which lead to the achieving of the business driver are not tracked and revised with changing times. Thus, the reasoning aspect of what, and which, activities are needed to attain the business driver is lost due to the absence of relevant knowledge.

The methodology and techniques described with respect to the exemplary embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The machine may include a processor (e.g., a central processing unit (CPU), a graphics processing unit (GPU, or both), a main memory and a static memory, which communicate with each other via a bus. The machine may further include a video display unit (e.g., a liquid crystal display (LCD), a flat panel, a solid state display, or a cathode ray tube (CRT)). The machine may include an input device (e.g., a keyboard) or touch-sensitive screen, a cursor control device (e.g., a mouse), a disk drive unit, a signal generation device (e.g., a speaker or remote control) and a network interface device.

The disk drive unit may include a machine-readable medium on which is stored one or more sets of instructions (e.g., software) embodying any one or more of the methodologies or functions described herein, including those methods illustrated above. The instructions may also reside, completely or at least partially, within the main memory, the static memory, and/or within the processor during execution thereof by the machine. The main memory and the processor also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions, or that which receives and executes instructions from a propagated signal so that a device connected to a network environment can send or receive voice, video or data, and to communicate over the network using the instructions. The instructions may further be transmitted or received over a network via the network interface device.

While the machine-readable medium can be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: tangible media; solid-state memories such as a memory card or other package that houses one or more read-only (non-volatile) memories, random access memories, or other re-writable (volatile) memories; magneto-optical or optical medium such as a disk or tape; non-transitory mediums or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

We claim:

1. A method for establishment and sustenance of Knowledge Continuity Process in a phase wise manner within an organization and/or among multiple organizations comprising knowledge drivers, business drivers, a leadoff team, a knowledge expert team, a knowledge administrator, knowledge distillation and diffusion, learning's from the past archive, business leagues, expert knowledge base, knowledge delivery characterized in that the method comprising:
identifying a predetermined stage “n” of the organization;
forming the leadoff team of individuals from the organization and from a knowledge vendor;
linking the knowledge drivers with the business drivers by the leadoff team by selecting knowledge drivers appropriate to business drivers based on organizational needs; and
measuring stage ‘n+1’ of the organization by individuals of the knowledge vendor; and
providing a continuous improvement.

2. The method as claimed in claim 1, wherein the leadoff team performing activities comprising:
creating knowledge categories;
forming the knowledge expert team for each of the knowledge driver; and
nominating the knowledge administrator for each of the knowledge category.

3. The method as claimed in claim 1 wherein the continuous improvement comprising:
managing an intellectual capital; and
periodically conducting a status assessment interviews.

4. A system for establishment and sustenance of Knowledge Continuity Process in a phase wise manner within an organization and/or among multiple organizations comprising knowledge drivers, business drivers, a leadoff team, a knowledge expert team, a knowledge administrator, knowledge distillation and diffusion, learning's from the past archive, business leagues, expert knowledge base, knowledge delivery characterized in that the method comprising:
means for identifying a predetermined stage “n” of the organization;
means for forming the leadoff team of individuals from the organization and from knowledge vendor;
means for linking the knowledge drivers with the business drivers by the leadoff team; and
means for measuring stage ‘n+1’ of the organization by individuals of the knowledge vendor; and means for providing a continuous improvement.

5. The system as claimed in claim 4, wherein the means for identifying comprising search engine means.

6. System as claimed in claim 4, wherein the means for Knowledge Distillation and Diffusion is done with assistance of expert knowledge base software, means for addressing to the queries raised by users.

7. The system as claimed in claim 4, wherein the leadoff team performing activities comprising:
means for creating knowledge categories;
means for forming the knowledge expert team for each of the knowledge drive; and
means for nominating the knowledge administrator for each of the knowledge category.

8. The system as claimed in claim 4, wherein the continuous improvement comprising:
means for managing an intellectual capital; and
means for periodically conducting a status assessment interviews.

9. The system as claimed in claim 4, further comprising a content management system (CMS).

10. The system as claimed in claim 9, wherein the CMS adapted to facilitate contribution and sharing of data between large number of users.

11. The system as claimed in claim 9, where the CMS further adapted for easy storage and retrieval of data in/from the database.
